(19) United States
(12) Patent Application Publication
(10) Pub. No.: US 2016/0269308 A1
(43) Pub. Date: Sep. 15, 2016

(54) METHOD AND APPARATUS FOR MANAGING DISTRIBUTED CLOUDS

(71) Applicant: ELECTRONICS AND TELECOMMUNICATIONS RESEARCH INSTITUTE, Daejeon (KR)

(72) Inventors: Jung-Hee LEE, Daejeon (KR); Bhum-Cheol LEE, Daejeon (KR); Jong-Geun PARK, Daejeon (KR); Seung-Hyun YOON, Daejeon (KR); Sang-Min LEE, Daejeon (KR)

(21) Appl. No.: 15/047,841

(22) Filed: Feb. 19, 2016

(30) Foreign Application Priority Data
Mar. 10, 2015 (KR) 10-2015-0033434

(51) Int. Cl. H04L 12/911; H04L 29/08

(52) U.S. Cl. CPC H04L 47/70; H04L 67/1097; H04L 67/18

(57) ABSTRACT

A method and an apparatus for integrated management/control of regionally distributed micro-cloud data centers. A system for managing distributed clouds includes an apparatus for managing distributed clouds and an apparatus for managing a plurality of micro-data centers. The apparatus for managing distributed clouds manages the plurality of micro-data centers, analyzes the service inputted by a user to generate optimal virtual resource information, and transmits it to the micro-data center. The micro-data center is allocated with optimal resource according to the inputted service analysis information and resource request information.

### CROSS REFERENCE TO RELATED APPLICATION

This application claims the benefit of Korean Patent Application No. 10-2015-0033434, filed on Mar. 10, 2015, entitled “Method and apparatus for managing distributed clouds”, which is hereby incorporated by reference in its entirety into this application.

### BACKGROUND

1. Technical Field

Exemplary embodiments of the present invention relate to management of data centers and more particularly, to a method and an apparatus for providing optimal resources based on service attributes through integrated management/control of regionally distributed cloud data centers.

2. Description of the Related Art

A cloud computing service is a service for providing computing environment where one can simultaneously use IT-related services, such as data storage, networking, contents and the like through a server on internet. A cloud data center to provide such services is composed with a plurality of servers and provides computing resources to each client.

Cloud centers are operated through a management systems, which are called cloud management platforms (or cloud OSs) present within the cloud centers. Cloud centers are usually increasingly being distributed in various locations, rather than residing in one location, due to a variety of issues such as electricity, regional issues, and networking issues. Particularly, micro LDCs (internet data centers), which involve placing small-scale cloud centers in many locations, are currently under discussion,

When directly controlling the resources (servers, storage, and networks) of a large number of cloud centers, which are a long distance away, through an internet, there are many issues regarding scalability of cloud management systems, delay of management and control signals, stability/reliability of management networks, and dealing with failures. KR Patent Application No. 10-2013-0086295 discloses “A method and system for managing cloud centers” filed by the same applicant to that of the present invention in order to solve these problems.

However, when the resources (servers, storage, and networks) of a large number of cloud centers, i.e., micro IDCs, which are a long distance away, are allocated and arranged through a network without analysis of service attributes, this leads to the problem of inefficient resource management and delays and lowered performances associated with unnecessary traffics on the network.

### SUMMARY

Accordingly, an object of exemplary embodiments the present invention is to provide a method and an apparatus for providing optimal resources to users based on service attributes (for example, proximity, locality and the like) through interoperation between an apparatus for managing distributed clouds which integratedly manages regionally distributed micro-data centers and an apparatuses for managing micro-data center arranged in each micro-data center.

According to an aspect of the present invention, there is provided a method for managing distributed clouds in a system for managing distributed clouds. The method may comprise: monitoring resources in a micro-data center and transmitting the monitored resource information to an apparatus for managing distributed clouds configured to manage a plurality of distributed micro-data centers, the resources being monitored and the monitored resource information being transmitted by an apparatus for managing micro-data center arranged in each of the plurality of distributed micro-data centers; when a cloud service is requested, analyzing attributes of the requested cloud service, the attributes being analyzed by the apparatus for managing distributed clouds; selecting at least one micro-data center among the plurality of distributed micro-data centers and a resource based on the resource information of the micro-data centers and the service attribute information, and generating resource allocation request information for the selected resource, the at least one micro-data center and the resource being selected and the resource allocation request information being generated by the apparatus for managing distributed clouds; and transmitting the service attribute information and the resource allocation request information to the selected micro-data center, the transmitting being performed by the apparatus for managing distributed clouds.

According to another aspect of the present invention, there is provided an apparatus for managing distributed clouds. The apparatus for managing distributed clouds may comprise: an integrated resource management unit configured to manage resource information of a plurality of distributed micro-data centers; a service analysis unit configured to analyze attributes of the cloud service which is requested by a user; an integrated resource control unit configured to select at least one micro-data center among the plurality of distributed micro-data centers and a resource based on the resource information of the micro-data centers and the service attribute information, and generate resource allocation request information for the selected resource; and a micro-data center interface unit configured to transmit the service attribute information and the resource allocation request information to the selected micro-data center.

According to further another aspect of the present invention, there is provided a method for managing distributed clouds. The method for managing distributed clouds may comprise: managing resource information of a plurality of distributed micro-data centers; analyzing attributes of the cloud service requested by a user; selecting at least one micro-data center among the plurality of distributed micro-data centers and a resource based on the resource information of the micro-data centers and the service attribute information, and generating resource allocation request information for the selected resource; and transmitting the service attribute information and the resource allocation request information to the selected micro-data center.

According to an embodiment of the present invention, optimal resources based on service attributes (for example, proximity, locality and the like) may be allocated by analyzing users' services. According to the present invention, capacity expansion and easy maintenance/management may be provided through distributed arrangement of micro-data centers using internet or leased line.

### BRIEF DESCRIPTION OF DRAWINGS

FIG. 1 is a schematic view illustrating a distributed cloud infra environment.

FIG. 2 illustrates a system for managing cloud data centers.

FIG. 3 is a block view illustrating structure of an apparatus for managing distributed clouds according to an embodiment of the present invention.

FIG. 4 is a block view illustrating structure of a micro-data center according to an embodiment of the present invention.

FIG. 5 is a flowchart illustrating a process for collecting resource information in a system for managing distributed clouds according to an embodiment of the present invention.

FIG. 6 is a flowchart illustrating a process for allocating resources in a system for managing distributed clouds according to an embodiment of the present invention.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

The terms used in the description are intended to describe certain embodiments only, and shall by no means restrict the present invention. Unless clearly used otherwise, expressions in the singular number include a plural meaning.

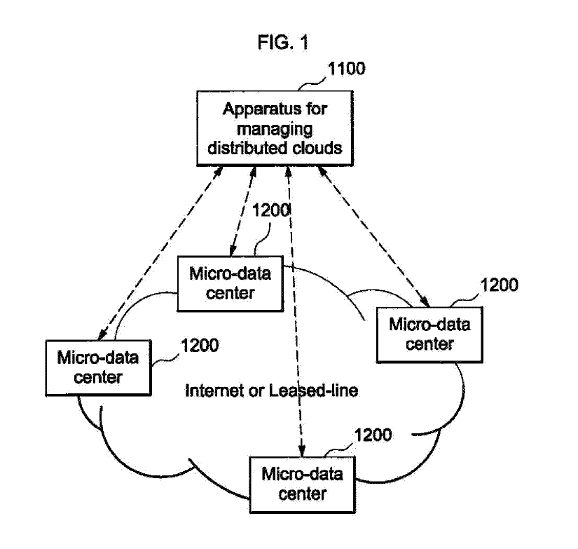

FIG. 1 is a schematic view illustrating a distributed cloud infra environment. As shown in FIG. 1, an apparatus for managing distributed clouds 1100 and a plurality of micro-data centers 1200 each of which is controlled by the apparatus for managing distributed clouds 1100 are connected through Internet or leased line. The apparatus for managing distributed clouds 1100 may provide multi-tenancy services (for example, networking, computing and the like) using resources in at least one micro-data center 1200 in response to a cloud service request of a user (or an operator). Communications between micro-data centers through Internet or leased line may be provided by various legacy methods, for example Virtual Private Network (VPN).

When there is insufficient capacity, a centralized data center may implement additional servers (or storages) and reconstruct data network and management network to connect to the additionally implemented servers. In this case, the implement may be conducted while power of the micro-data center is turned off and services are temporary suspended. However, when capacity expansion is required in distributed cloud data centers, capacity may be expanded by connecting to the internet (or leased-line) with micro-data center unit so that high availability may be provided without suspension of services and maintenance/management may be facilitated. A plurality of micro-data centers may be arranged in the same location or within a building or may be distributed in various locations.

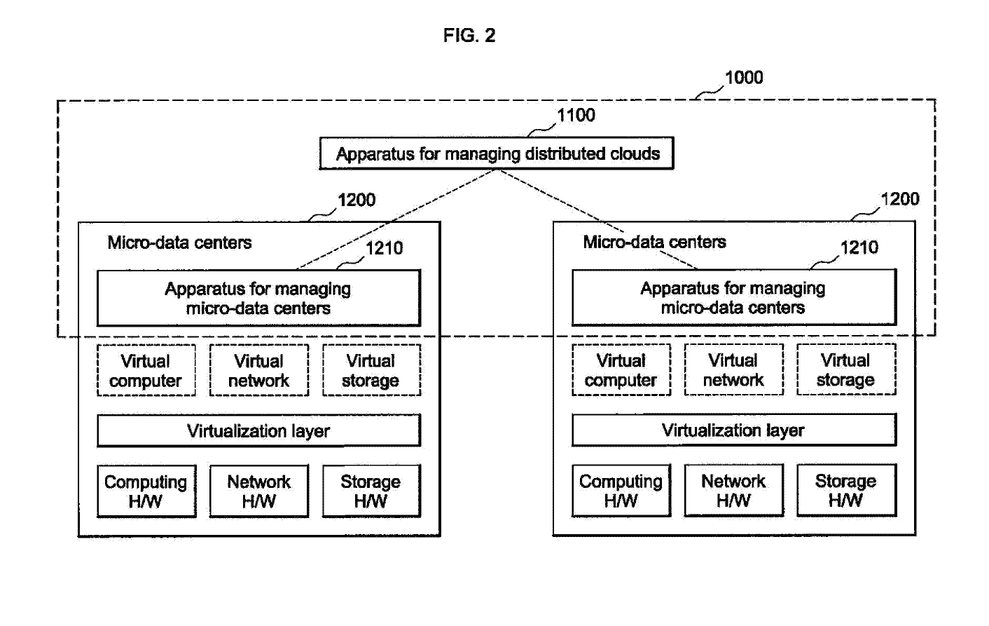

FIG. 2 illustrates a system for managing cloud data centers. Only two micro-data centers 1200 are illustrated for convenience of explanation in FIG. 2 but it is apparent to those skilled in the art that more than 2 micro-data centers may be arranged.

As shown in FIG. 2, a system for managing distributed clouds 1000 may comprise an apparatus for managing micro-data center 1210 configured to monitor and manage resources in each micro-data center by being arranged in each distributed micro-data center 1200 and an apparatus for managing distributed clouds 1100 configured to integratedly manage the micro-data centers 1200.

The apparatus for managing distributed clouds 1100 may control and manage the micro-data centers 1200 which are regionally distributed through network such as internet or leased-line and further perform network topology management and resource allocation between the micro-data centers 1200. The apparatus for managing distributed clouds 1100 may interlockingly operate with the apparatus for managing micro-data centers 1210 arranged in the micro-data centers 1200.

The micro-data center 1200 may include various resources (for example, computing H/W, network H/W, storage H/W) for cloud computing services. The apparatus for managing micro-data center 1210 which is arranged in each micro-data center may manage and monitor resources in the micro-data center and generate, if needed, virtual resources based on physical resources using virtualization techniques. Furthermore, when there is any resource information change in the micro-data center due to the arrangement of new resources, addition or removal of resources, presence of a defect and the like, the apparatus for managing micro-data center 1210 may transmit information related to such change to the apparatus for managing distributed clouds 1100.

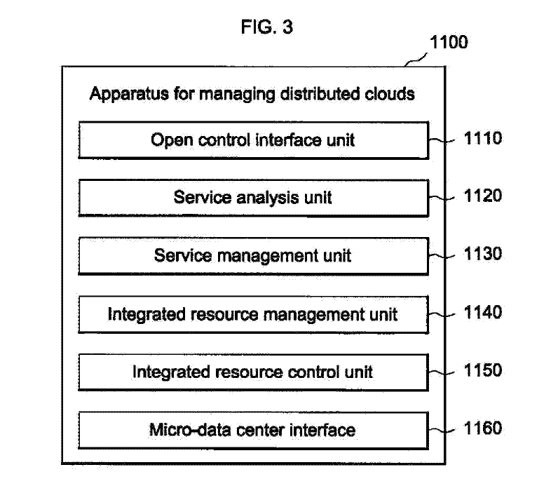

FIG. 3 is a block view illustrating structure of an apparatus for managing distributed clouds according to an embodiment of the present invention. As shown in FIG. 3, the apparatus for managing distributed clouds 1100 may include an open control interface unit 1110, a service analysis unit 1120, a service management unit 1130, an integrated resource management unit 1140, an integrated resource control unit 1150 and a micro-data center interface 1160 but a part of the components may be omitted.

The open control interface unit 1110 may provide an application program interface (API) to process cloud infra and service control/management messages of a user or a system manager and perform user authorization and authentication for the received cloud service request or management message through a remote cloud management system client or a command line interface (CLI) and the like. The open control interface unit 1110 may also process the requested message and transmit the processed result (including fault information) to the user or the system manager.

The service analysis unit 1120 may analyze attributes of cloud service transmitted from the open control interface unit 1110. For example, the service analysis unit 1120 may provide proximity when the requested service is a VDI (Virtual Desktop Infra) or CDN (Content Delivery Network) service and provide locality when the requested service is a region-specific advertising service.

The service management unit 1130 may perform user-based service control/management based on the service analysis information analyzed by the service analysis unit 1120.

The service management unit 1130 may generate a service control/management request message for control/management of services such as creating, modifying, deleting, starting, pausing, resuming, stopping and the like to transmit to the integrated resource management unit 1140. The service management unit 1130 may manage service level agreement (SLA) and the like according to user and generate information of current status of use according to service based on the information of current status of use and the like collected by the integrated resource management unit 1140 to use for billing and other operation managements.

The integrated resource management unit 1140 may manage resource information of the micro-data centers which are integratedly controlled by the apparatus for managing distributed clouds 1100. Here, the resource information may include network resource information which connects to the micro-data centers in addition to virtual/physical resource information. In an embodiment, when there is any resource information change in the micro-data center due to the arrangement of new resources, addition or removal of resources, presence of a defect and the like, the resource information may be collected by the micro-data center to be transmitted to the apparatus for managing distributed clouds 1100.

The integrated resource management unit 1140 may collect resource information periodically from the micro-data centers.

The integrated resource control unit 1150 may generate resource allocation request information for at least one micro-data center among the plurality of micro-data centers based on the resource information of the micro-data centers which are managed by the integrated resource management unit 1140 and the service attribute information analyzed by the service analysis unit 1120. The integrated resource control unit 1150 may estimate amount of resource allocation by checking location of each micro-data center and surplus resources in addition to information of capacity of resources distributed in the micro-data center, location of resources, connected network and internet or leased-line. The integrated resource control unit 1150 may select at least one micro-data center to allocate service, and generate resource allocation request information needed to transmit the selected micro-data center.

In an embodiment when the analyzed service attribute represents proximity, the integrated resource control unit 1150 may generate resource allocation request information for the resource close to the user.

In another embodiment, when the analyzed service attribute represents locality, the integrated resource control unit 1150 may generate resource allocation request information for the resource in a region where the user is located.

The micro-data center interface 1160 may transmit service analysis information and resource request information by communicating with the micro-data center 1200.

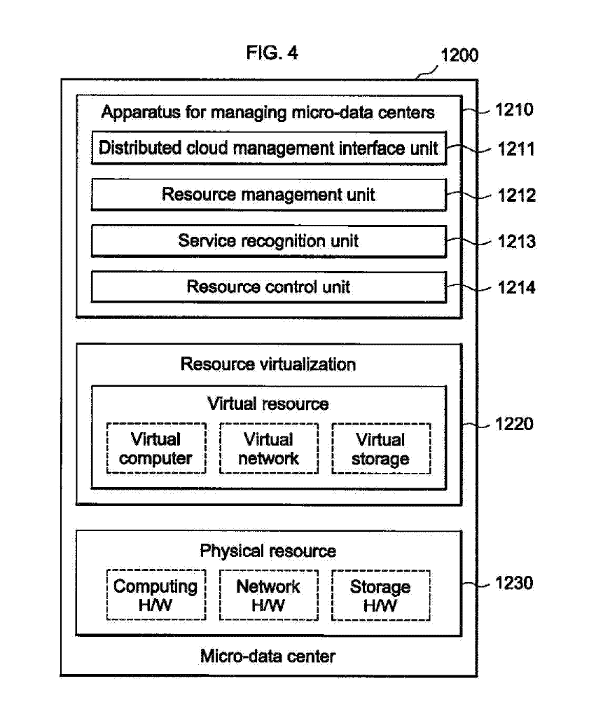

FIG. 4 is a block view illustrating structure of a micro-data center according to an embodiment of the present invention.

A micro-data center 1200 may include an apparatus for managing micro-data center 1210, a resource virtualization 1220 and a physical resource 1230. The apparatus for managing micro-data center 1210 may include a distributed cloud management interface unit 1211, a resource management unit 1212, a service recognition unit 1213 and a resource control unit 1214. At least one component of them may be omitted.

The distributed cloud management interface unit 1211 may receive service analysis information and resource request information from the apparatus for managing distributed clouds 1100 by communicating with the apparatus for managing distributed clouds 1100 and transmit resource information in the micro-data center 1200 to the apparatus for managing distributed clouds 1100.

The resource management unit 1212 may collect and store individual resource information in the micro-data center 1200. The resource management unit 1212 may also abstract and summarize the collected individual resource information to transmit it to the apparatus for managing distributed clouds 1100. The resource management unit 1212 may provide resource information periodically to the apparatus for managing distributed clouds 1100 or provide resource information whenever there is any resource information change in the micro-data center due to the arrangement of new resources, addition or removal of resources, presence of a defect and the like, or provide according to the request of the apparatus for managing distributed clouds 1100.

The service recognition unit 1213 may recognize attributes of the service transmitted from the apparatus for managing distributed clouds 1100. In an embodiment, the service recognition unit 1213 may recognize whether the request service is a service needed for proximity or locality. In addition, various service classifications may be possible according to various policies. The service recognition unit 1213 may transmit resource request information necessary to the recognized service to the resource control unit 1214. For example, if it is a service requiring a high performance server, the service recognition unit 1213 may request allocation of high performance server resource, while if it is a service requiring a low performance server, the service recognition unit 1213 may request allocation of low performance server resource. Furthermore, the service recognition unit 1213 may control creating, modifying, deleting, starting, pausing, resuming, stopping and the like of services in the micro-data center 1200.

The resource control unit 1214 may dynamically create, modify, delete, move virtual resources (virtual computer, virtual network, virtual storage and the like) based on individual physical resources on the bottom layer by controlling a virtualization layer such as hypervisor. The resource control unit 1214 may also monitor information of current status of use of physical resources and virtual resources in the micro-data center to transmit the result to the resource management unit 1212.

The resource virtualization 1220 may include a virtualization unit (not shown) and a virtual resource (virtual computer, virtual network, virtual storage and the like). The virtualization unit (for example, hypervisor) is a layer virtualizing physical resources. The virtual resource may be generated according to control of the resource control unit 1214 and include at least one of a virtual computer, a virtual storage and a virtual network. The physical resource 1230 may include at least one of a computing hardware, storage hardware and network hardware.

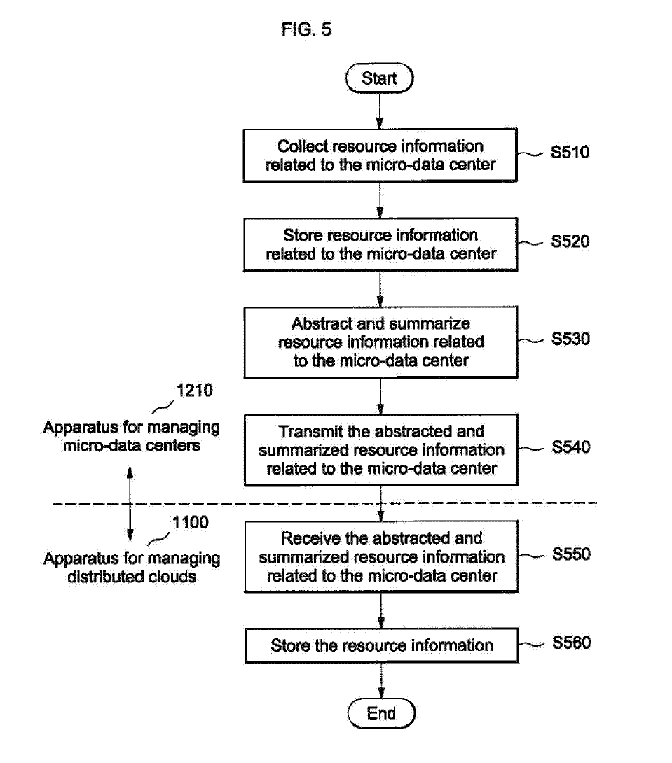

FIG. 5 is a flowchart illustrating a process for collecting resource information in a system for managing distributed clouds according to an embodiment of the present invention.

A system for managing distributed clouds needs to collect and manage resource information of each micro-data center which itself manages prior to proceeding a cloud service. Thus, when there is any resource (status) information change in the distributed micro-data center due to the arrangement of new resources, addition or removal of resources, presence of a defect and the like, the apparatus for managing micro-data center 1210 arranged in each distributed micro-data center may collect resource (status) information related to the micro-data center in S510.

The apparatus for managing micro-data center 1210 may store the collected resource information in S520.

When the collection is completed, the apparatus for managing micro-data center 1210 may abstract and summarize the stored resource information in S530 and transmit the abstracted and summarized resource information to the apparatus for managing distributed clouds 1100 in S540. Furthermore, the apparatus for managing micro-data center 1210 may additionally transmit service availability, service types offered and the like of status information in the micro-data center.

The apparatus for managing distributed clouds 1100 may receive the abstracted and summarized resource information for each micro-data center from the apparatus for managing micro-data center 1210 in each micro-data center in S550 and store the received resource information of the micro-data center in S560. The received resource information of the micro-data center may be then used for service provisioning/management.

In above-described embodiment, information is collected when there is any resource information change of the micro-data center. In another embodiment, the apparatus for managing distributed clouds 1100 may instruct to the apparatus for managing micro-data center 1210 arranged in the micro-data center to perform a process for collecting resources as described above.

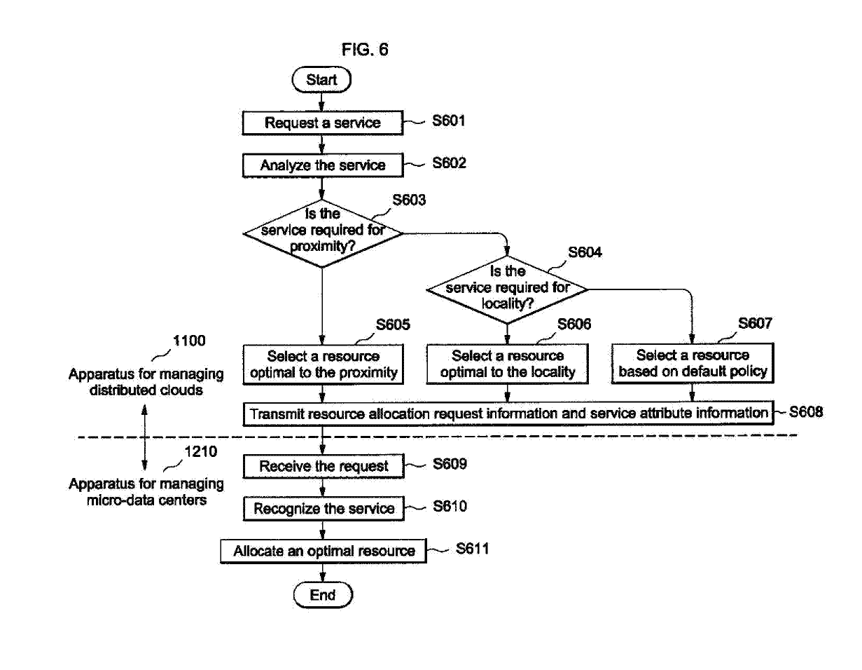

FIG. 6 is a flowchart illustrating a process for allocating resources in a system for managing distributed clouds according to an embodiment of the present invention.

When a service request is received from a user or a manager in S601, the apparatus for managing distributed clouds 1100 may analyze attributes of the service for resource allocation necessary to the service in S602.

A cloud computing service is a service that provides a computing resource to the one who wants cheaply and fast through development of computers and storages in large quantities in one location and virtualization. Many communications may be expected between a virtual application server and a virtual terminal or a (virtual) application server of another provider in the cloud computing environment and qualities and traffics may vary with arrangements thereof.

The apparatus for managing distributed clouds 1100 may determine whether proximity is needed for the service based on the result analyzed for attributes of the service in S603 and select resources close to the user in S605. For example, a VDI or CDN service belongs to this case. The apparatus for managing distributed clouds 1100 may then determine whether locality is needed for the service in S604 and select server resources in a region where the user is located in S606. For example, an advertising service for a specific region belongs to this case. In addition, resources may be selected based on default policy in S607.

The embodiments are cases of resource allocation based on proximity/locality among service attributes. In addition, cost optimized resource allocation may be provided through various service classifications.

For example, resource allocation may be obtained according to performance requirement (delay, QoS and the like) through analysis of services.

Amount of resource allocation may be estimated by checking location of each micro-data center and surplus resources in addition to information of capacity of resources distributed in the micro-data center, location of resources, connected network and internet (or leased-line), at least one micro-data center to allocate service may be selected; and resource allocation request information and service attribute information may be transmitted to the selected at least one micro-data center in S608.

When the service attribute information and the resource allocation request information are received from the apparatus for managing distributed clouds 1100 in S609, the apparatus for managing micro-data center 1210 of the micro-data center may recognize services in S610 and allocate an optimal resource related to the service attribute and the resource allocation request in S611.

For example, the apparatus for managing micro-data center 1210 may recognize whether the service is able to be provided with a high performance server or a low performance server and performs the resource allocation according to the recognized result. The apparatus for managing micro-data center 1210 may check individual resources of the micro-data center corresponding to the requested resource and perform resource allocation based on the request. In this case, a server image file to drive a virtual server defined in a tenant may be received along with the resource allocation request information from the apparatus for managing distributed clouds 1100. Or it may be transmitted in advance from the apparatus for managing distributed clouds 1100 to the apparatus for managing micro-data center 1210 of the micro-data center.

Exemplary embodiments of the present invention may be implemented in a computer system, for example, a computer readable recording medium. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

What is claimed is:

1. A method for managing distributed clouds in a system for managing distributed clouds, the method comprising:
monitoring resources in a micro data center and transmitting the monitored resource information to an apparatus for managing distributed clouds configured to manage a plurality of distributed micro-data centers, the resources being monitored and the monitored resource information being transmitted by an apparatus for managing micro-data center arranged in each of the plurality of distributed micro-data centers;
when a cloud service is requested, analyzing attributes of the requested cloud service, the attributes being analyzed by the apparatus for managing distributed clouds,
selecting at least one micro-data center among the plurality of distributed micro-data centers and a resource based on the resource information of the micro-data centers and the service attribute information, and generating resource allocation request information for the selected resource, the at least one micro-data center and the resource being selected and the resource allocation request information being generated by the apparatus for managing distributed clouds; and
transmitting the service attribute information and the resource allocation request information to the selected micro-data center, the transmitting being performed by the apparatus for managing distributed clouds.

2. The method of claim 1, further comprising allocating a resource corresponding to the service attribute and the resource allocation request, the allocating being performed by the apparatus for managing micro-data center of the micro-data center, which has received the service attribute information and the resource allocation request information.

3. An apparatus for managing distributed clouds, comprising:
an integrated resource management unit configured to manage resource information of a plurality of distributed micro-data centers;
a service analysis unit configured to analyze attributes of the cloud service which is requested by a user;
an integrated resource control unit configured to select at least one micro-data center among the plurality of distributed micro-data centers and a resource based on the resource information of the micro-data centers and the service attribute information, and generate resource allocation request information for the selected resource; and
a micro-data center interface unit configured to transmit the service attribute information and the resource allocation request information to the selected micro-data center.

4. The apparatus of claim 3, wherein the resource information, when resource change is caused in the micro-data center, is collected by the micro-data center to be transmitted to the apparatus for managing distributed clouds.

5. The apparatus of claim 3, wherein the resource information is periodically collected by the integrated resource management unit.

6. The apparatus of claim 3, wherein the integrated resource control unit, when the service attribute represents proximity, selects a resource and a micro-data center close to the user.

7. The apparatus of claim 3, wherein the integrated resource control unit, when the service attribute represents locality, selects a resource and a micro-data center in a region where the user is located.

8. A method for managing distributed clouds, comprising:
managing resource information of a plurality of distributed micro-data centers;
analyzing attributes of the cloud service requested by a user;
selecting at least one micro-data center among the plurality of distributed micro-data centers and a resource based on the resource information of the micro-data centers and the service attribute information, and generating resource allocation request information for the selected resource; and
transmitting the service attribute information and the resource allocation request information to the selected micro-data center.

9. The method of claim 8, wherein the resource information is received whenever resource change is caused from the micro-data center.

10. The method of claim 8, wherein the resource information is periodically collected.

11. The method of claim 8, wherein the step of generating resource allocation request information comprises generating resource allocation request information for the resource which is close to the user when the service attribute represents proximity.

12. The method of claim 8, wherein the step of generating resource allocation request information comprises generating resource allocation request information for the resource in a region where the user is located when the service attribute represents locality.
